(19) United States
(12) Patent Application Publication
(10) Pub. No.: US 2025/0346690 A1
(43) Pub. Date: Nov. 13, 2025

(54) METAL ION-INFUSED POLYMERS AND METHOD OF MAKING METAL ION-INFUSED POLYMERS

(71) Applicant: MinRay, LLC, Wake Forest, NC (US)

(72) Inventors: Thomas J. Webster, Barrington, RI (US); Matthew B. Hedrick, Carmel, IN (US); Jeffrey D. Forbes, Wake Forest, NC (US)

(21) Appl. No.: 19/202,695

(22) Filed: May 8, 2025

Related U.S. Application Data
(60) Provisional application No. 63/646,259, filed on May 13, 2024.

(51) Int. Cl. C08F 8/42; C08J 7/14

(52) U.S. Cl. CPC C08F 8/42; C08J 7/14; C08F 2800/20; C08J 2367/03; C08J 2375/04

(57) ABSTRACT

A method of making a metal ion-infused polymer includes: dissolving a powder comprising a metal in an acid solution, thereby forming a metal ion solution; mixing the metal ion solution with a solution or melt comprising a polymer, thereby forming a metal ion-polymer mixture; exposing the metal ion-polymer mixture to a supercritical fluid, whereby acid(s) and/or solvent(s) are removed from the mixture; and, after the supercritical fluid exposure, drying the metal-ion polymer mixture to form a metal ion-infused polymer. A metal ion-infused product comprises a fiber, yarn, suture, surgical thread, fabric, textile, film, and/or shaped body including a metal ion-infused polymer that comprises a polymer backbone and metal ions bound to or incorporated into the polymer backbone, where the metal ions are present at a concentration in a range from 0.0001 wt. % to less than 65 wt. %.

### RELATED APPLICATION

The present patent document claims the benefit of priority under 35 U.S.C. 119 (e) to U.S. Provisional Patent Application No. 63/646,259, which was filed on May 13, 2024, and is hereby incorporated by reference in its entirety.

### TECHNICAL FIELD

This disclosure relates generally to polymer technology and more particularly to a method of dispersing metal ions in polymers for the enhancement of various properties.

### BACKGROUND

Polymer composites include a polymer matrix and an additive dispersed in the matrix to provide enhanced functionality, such as increased electrical conductivity or antimicrobial properties. Traditionally, such functional additives are incorporated into a base polymer using a masterbatch, which is a concentrated mixture including the additive and a carrier polymer that is compatible with or identical to the base polymer. The masterbatch is then combined with the base polymer using conventional polymer processing methods. A typical weight percentage of the masterbatch to the base polymer is 1-5%, such that the final polymer composite includes only small amounts of the desired additive. Using these traditional methods, incorporation of large amounts of a desired additive into a polymer matrix is difficult if not impossible. The challenges may include precipitation of large particles out of solution, inhomogeneity in the additive distribution, and reduction in polymer strength and increased wear due to processing and manufacturing equipment using particle-based additives. The limit on the amount and type of additives limits the magnitude and duration of the desired effect of the additive, forcing the use of additional materials to achieve a desired effect, or reducing the total effect achieved.

### BRIEF DESCRIPTION OF THE DRAWINGS

The embodiments may be better understood with reference to the following drawings and description. The components in the figures are not necessarily to scale.

FIG. 1 shows a flow chart of exemplary steps in a method to make metal ion-infused polymers.

FIGS. 2A and 2B are schematics illustrating possible chemistries for the metal ions in the polymer backbones.

FIGS. 3A and 3B are scanning electron microscope (SEM) images (magnification=2500×) of polypropylene samples infused with W ions from WC powders at a concentration of 55 wt. %.

FIGS. 3C and 3D are SEM images (magnification=2500×) of polypropylene samples infused with W and Se ions from WC and Se powders at a metal (W+Se) concentration of 55 wt. %.

FIG. 4 is an SEM image (magnification=2500×) of a polypropylene sample with W and Se incorporated at a concentration of 65 wt. %; in this example, metal-containing particles are formed.

FIG. 5 shows energy dispersive x-ray spectroscopy (EDS) data of a titanium ion-infused polyurethane sample.

FIG. 6 shows differences in the contact angle of a water droplet on unmodified polyurethane (left hand image) versus a titanium ion-infused polyurethane sample (right hand image).

FIG. 7 shows differences in the contact angle of a water droplet on unmodified polyethylene terapthalate (PET; left hand image) versus a titanium ion-infused PET sample (right hand image).

FIG. 8 shows a series of bar graphs of polypropylene (PP) samples of different molecular weights and with various concentrations of WC and Se, showing decreased methicillin-resistant Staphylococcus aureus (MRSA), Pseudomonas aeruginosa (PA), and E. coli colonization after 24 hours.

FIG. 9 is a bar graph showing reduced MRSA colonization on polyester clothes with WC added.

### DETAILED DESCRIPTION

Described in this disclosure is a method of making a metal ion-infused polymer having improved properties due to the presence of a tailorable concentration of metal ions. Commercially important polymers can be processed to include small or large amounts of metal ions using this new approach, which combines metal dissolution, polymer mixing, and supercritical fluid exposure. The metal ion-infused polymers resulting from the method may exhibit enhanced strength/durability, bacterial resistance, radiopacity, hydrophilicity, heat dissipation, conductivity, and/or other improved properties compared to neat polymers, and may be produced in the form of fibers, fabrics, powders, granules, blocks, rods, solutions, films, etc., for use in medical devices, garments, fabrics, and other products for medical or non-medical uses.

Referring to the flow chart of FIG. 1, the method comprises dissolving 102 a precursor material comprising a metal in an acid solution, such that metal ions are released and dispersed, forming a metal ion solution. Any of a number of precursor materials may be employed, including powder, particles, granules, or another form that can serve as a source of metal ions upon dissolution in the acid solution may be used. For example, the precursor material may comprise a pure metal (e.g., Se), a metal oxide (e.g., TiO₂), or a metal carbide (e.g., tungsten carbide (WC)). The metal/metal ions may be selected based on the intended properties (e.g., bacterial resistance, radiopacity, durability, etc.) of the resulting metal ion-infused polymer. Suitable metals may include Ag, Au, Bi, Cr, Cu, Mg, Pd, Pt, Se, Sn, W, Zn, Ti, Ta, Ba, and/or Al. The acid solution employed for dissolution may include one or more acids capable of dissolving metals, such as nitric acid, hydrochloric acid, and/or sulfuric acid. In one example, an aqua regia solution including both nitric and hydrochloric acid, typically in a 1:3 ratio by volume, may be employed. The metal ion solution may include more than one type of metal ion if desired. Accordingly, the precursor material employed as the source of metal ions may comprise at least two different metals. For example, the precursor material may include at least two powder batches, each comprising a different metal (e.g., a Se powder and a WC powder), and/or the powder may include individual particles that include at least two different metals (e.g., Ti—Al metal alloy particles).

The metal ion solution including the acid-dissolved precursor material is mixed 104 with a solution containing a dissolved polymer, such that a metal ion-polymer mixture is formed. To form the solution, a polymer, typically in the form of pellets or beads, may be dissolved in a suitable solvent, such as chloroform. Alternatively, it is contemplated that the polymer may be heated to form a melt, and the resulting polymer melt may be mixed with the acid-dissolved powder without utilizing a solvent. Notably, the one or more acids used to dissolve the metal-containing powder may be selected based on their compatibility with the polymer and/or with any solvents used for polymer dissolution. It is believed that the dissolution of the metal in the acid solution prior to combining with the polymer solution or melt is a unique feature of the method that enables high loading levels of metal ions to be incorporated into the polymer while retaining the desired metallic properties. The mixing of the metal ion solution with the dissolved polymer solution or polymer melt may entail agitation, sonication, mechanical stirring or magnetic stirring in order to ensure that a homogeneous blend of the two solutions is formed. The dissolution and mixing may be carried out under ambient conditions (e.g., atmospheric pressure and room temperature, or about 18-25° C.).

The amount of powder or other precursor material dissolved in the acid solution may be selected to provide a desired concentration of metal ions in the metal ion-infused polymer. In other words, the mass of metal (and thus the amount of powder) employed to form the acid solution may be chosen based on the mass of polymer used to form the polymer solution or melt. The volume of acid required to dissolve the powder may be determined by eye, and additional acid may be added as needed to ensure dissolution of the entire mass of powder. Similarly, the volume of solvent required to dissolve the polymer may be determined by eye, and additional solvent may be added as needed to ensure dissolution of the entire mass of polymer.

Referring again to the flow chart of FIG. 1, after dissolution 102 and mixing 104, the metal ion-polymer mixture may be exposed 106 to a supercritical fluid, whereby any acids and/or solvents are removed from the metal-ion polymer mixture. A supercritical fluid is a substance in a supercritical state where distinct gaseous and liquid phases do not exist; that is, the substance is at a temperature and pressure above its critical point, which is defined by a critical temperature (T_{c}) and critical pressure (P_{c}). The supercritical fluid employed in the method may comprise carbon dioxide (CO₂), which has a critical point at a temperature T_{c} of 31.1° C. and a pressure P_{c} of 7.38 MPa. The inventors have recognized that the dissolving power of the supercritical fluid may be exploited for removal of acids and solvents from the metal ion-polymer mixture without impacting the dispersed metal ions, which are believed to be bound to or chemically incorporated into the polymer backbone, as discussed below. The metal ion-polymer mixture may be exposed to the supercritical fluid for a time duration sufficient to remove the acid(s) and/or solvent(s) from the mixture. In some examples, e.g., for small volume samples, the time duration may be as short as a few minutes (e.g., from 2 min to 30 min). In other examples, longer time durations (e.g., from 12 hours to 48 hours) may be beneficial or necessary. Prior to the exposure to the supercritical fluid, the metal ion-polymer mixture may be outgassed to reduce the time required for supercritical extraction. A lab-scale or production-scale supercritical fluid device, such as the SFE Lab or SFE Prod supercritical CO₂ extraction system by SFE Process, may be employed. This step is beneficial as residual acid(s) or solvent(s) may have detrimental effects on the final polymer, such as diminished mechanical properties and/or increased toxicity.

The metal ion-polymer mixture is in liquid form after the supercritical fluid treatment and may be dried 108 to ensure curing or solidification of the polymer and removal of any remaining acid or solvent. The drying may take place in a vacuum oven at a pressure in a range from 0 to 0.6 atm, for example, for a period of 12-48 hours or another suitable time duration. Upon drying, a metal ion-infused polymer is obtained. Advantageously, the concentration of metal ions in the final metal ion-infused polymer may lie in a broad range from 0.0001 wt. % to 65 wt. %, as discussed below. In some examples, the solid polymer formed as described above may undergo cutting or grinding to obtain pellets, beads or granules comprising the metal ion-infused polymer. For example, a commercially available pelletizer such as the Extrud-O-Mix by Bepex may be used to produce pellets.

The metal ion-infused polymer may be further processed into a metal ion-infused product comprising a fiber, yarn, suture, surgical thread, fabric, textile, film, coating, and/or shaped body using any suitable polymer processing method, such as extrusion, melt spinning, electrospinning, spraying, dipping, vapor deposition or other coating methods, pouring, molding, or 3D printing. These methods may entail melting the metal ion-infused polymer followed by delivery through a die, spinneret or nozzle, deposition, dipping, or pouring onto a surface, or delivery into a mold, for example, followed by solidification or curing. Yarns may be formed from fibers using twisting methods known in the art, and textiles may be woven or knitted from the fibers or yarns using methods known in the art. The polymer may further be coated, dyed or otherwise treated using techniques known in the art. The resulting metal ion-infused product may form part or all of a medical device, military garment, outdoor gear or material, lawn furniture or awning, marine fabric, or a consumer product, for example. Various applications are discussed below.

The polymer employed in the method may be a natural or synthetic polymer. In some examples, the polymer may be biocompatible, biodegradable, and/or bioresorbable. Examples of suitable polymers may include poly(methyl methacrylate) (PMMA), polyetheretherketone (PEEK), polyetherketoneketone (PEKK), polypropylene (PP), polyester, polyurethane (PU), polyethylene, ultra-high molecular weight polyethylene (UHMWPE), polyethylene terephthalate (PET), poly(lactic-co-glycolic) acid (PLGA), poly(vinyl chloride) (PVC), poly(vinylidene difluoride) (PVDF), nylon, acrylic, spandex, elastane, neoprene, rayon, collagen, alginate, chitosan, silk, and/or cellulose. The solvent used to dissolve the polymer may include butylated hydroxytoluene (BHT), chloroform, dichloroacetic acid, dichloromethane (DCM), dimethyl sulfoxide (DMSO), tetrahydrofuran (THF), 1,2,4-trichlorobenzene (TCB), water, and/or an aqueous solution.

Functional additives may be incorporated into the metal-ion infused polymer using techniques known in the art. The selected additive(s) may be incorporated to improve processing and/or to enhance particular properties of the metal ion-infused polymer. For example, carbon-based additives (e.g., carbon black, graphite, graphene, and/or carbon nanotubes) may be incorporated into the metal ion-polymer mixture to alter the electrical and/or thermal conductivity of the metal ion-infused polymer.

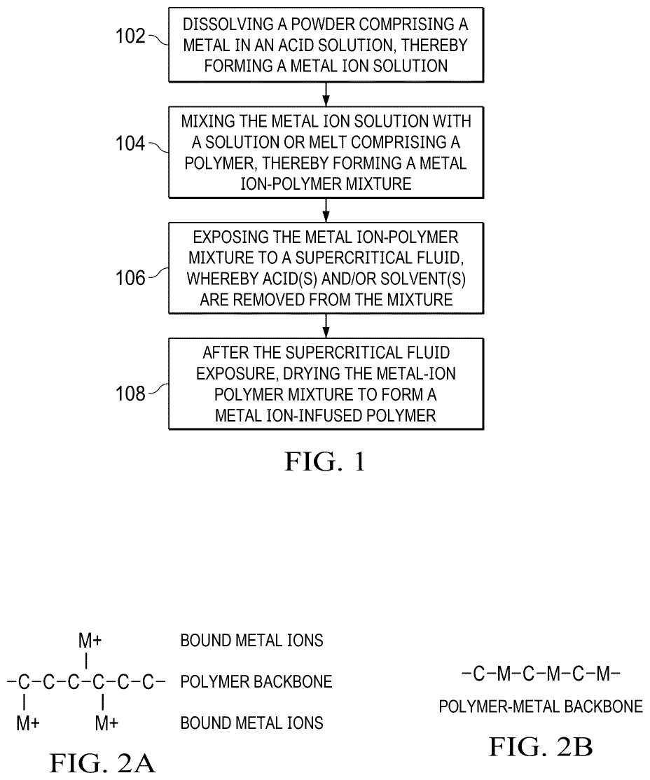

It is believed, based on experiments described below, that the metal ion-infused polymer includes polymer chains with metal ions bound to or chemically incorporated into the polymer chains, as illustrated in FIGS. 2A and 2B, respectively. The term “polymer backbone” refers to these polymer chains, which include atoms defining the chemical composition of the polymer. In some examples, the metal ions may be bound to functional groups attached to the polymer chains. Given the optional use of precursor materials such as metal oxides or metal carbides that include additional elements (e.g., carbon, oxygen) besides the metal, it is believed that some amount or all of the additional element(s) may also be chemically incorporated into the metal ion-infused polymer. As described above, the metal ions may have a tailorable concentration within the polymer, e.g., in a range from 0.0001 wt. % to less than 65 wt. %, and in some examples this concentration range may cover the additional element(s) incorporated within the precursor material. An attribute of the method is that high metal ion concentrations can be achieved along with uniform dispersion of the metal ions throughout the polymer, and precipitation of nano- or microparticles can be largely or entirely avoided. Accordingly, the weight percentage of metal ions and optionally additional element(s) incorporated into the polymer may be, in some examples, at least 15 wt. %, at least 25 wt. %, at least 35 wt. %, at least 45 wt. %, and/or up to 55 wt. %, or up to 60 wt. %. At or above 65 wt. %, the polymer may include some amount of nano- and/or microparticles comprising the metal, in addition to the metal ions. At or below metal ion concentrations of about 60 wt. % (e.g., 55 wt. %), the metal ion-infused polymer may be devoid of metal-containing nano- or micro-particles.

Due to the incorporation of a controlled amount of metal ions into the polymer, the polymer may have enhanced properties compared to unmodified (or “neat”) versions of the polymer. For example, the hydrophilicity of the metal ion-infused polymer may be improved. Data below reveal that the metal ion-infused polymer may exhibit, upon exposure to water, a water contact angle of less than 50 degrees, less than 40 degrees, or less than 20 degrees. The water contact angle may also or alternatively be as low as 10 degrees, or as low as 0 degrees. Additionally, the surface energy of the metal ion-infused polymer may be at least 60 mJ/m², at least 75 mJ/m², at least 100 mJ/m², or at least 125 mJ/m². In some examples, the surface energy may be as high as 130 mJ/m². High surface energies and hydrophilicity may be beneficial to resist platelet aggregation or bacterial attachment on fluid-contacting medical devices such as catheters. Also or alternatively, it may be possible to modify the attachment of bacterial and/or mammalian cells by controlling the surface energy/hydrophilicity of the metal ion-infused polymer. Micro- or nanotexturing of the polymer surface may allow for further control over the surface properties of the metal ion-infused polymer. There may be synergy between these surface enhancements and the antimicrobial properties inherent to metal ions such as silver and copper that enable the creation of antimicrobial, anti-platelet adhesion catheters and other types of devices. It is noted that the bacteriostatic properties of the metal ion-infused polymer may be enhanced by exposure to ultraviolet (UV) light. In another example, mechanical strength and durability may be improved. As shown in the examples below, the tensile and compressive strength of the metal ion-infused polymer may be at least 1.1 times higher, and in some examples 1.5 to 3 times higher than that of the unmodified polymer. In yet another example, antimicrobial properties may be enhanced. As substantiated below, bacterial colonization of the metal ion-infused polymer may be reduced by at least 20% or by at least 50% compared to the unmodified polymer. In addition to medical device applications, these properties may be exploited in antimicrobial fabrics and clothing (e.g., socks).

Various applications are enabled by the metal ion-infused polymers described in this disclosure. In one example, a metal ion-infused polymer (e.g., metal ion-infused PMMA) may be used to secure primary and secondary joint replacement implants to host bone. The high loading levels that can be achieved for metal ions such as Se, Zn, Ti and Ta may allow for a significant enhancement in PMMA's ability to inhibit or prevent bacterial colonization or kill bacteria in primary and secondary total joint arthroplasty. For the same application, metal ion-infused polymers may be used as temporary spacers to inhibit and/or treat periprosthetic joint infections. In some examples, an ultraviolet (UV) light generating device may be employed to irradiate the temporary spacer with UV light in order to enhance the bacteriostatic characteristics of the metal ions.

In another example, non-absorbable sutures capable of anchoring soft tissues to bone, and/or non-absorbable anchors in bone for securing soft tissues with sutures, may be formed from the metal ion-infused polymer. Advantages of utilizing a polymer with a desired loading level of metal ions for these applications may include improved radiopacity, higher mechanical strength, reduced bacterial attachment, increased bactericidal properties and/or increased hydrophilicity, which may improve the healing environment. Cell attachment and/or bone attachment may be improved.

The metal ion-infused polymers may also or alternatively be used, possibly in conjunction with other materials, to make interbody fusion devices for spine surgery. As an example, metal ions could be combined with natural biomaterials such as calcium phosphates, hydroxyapatite, bone, collagen, elastin, chitosan, hyaluronic acid, decellularized tissues, skin, and others to improve properties using these processes. As above, the advantages of utilizing the metal ion-infused polymer over unmodified polymers may include increased hydrophilicity, improved strength profile, and enhanced bacteriostatic and bactericidal properties of the devices, particularly in conjunction with UV light exposure.

Other applications outside of medical products and devices may include fabrics and textiles having radiation shielding capability, improved strength and durability, and/or other properties, such as electrical conductivity, thermal conductivity and/or hydrophilicity. In one example, the metal ion-infused polymers may be used to extrude yarn fibers for the purpose of knitting or weaving fabrics that have radiation shielding capabilities throughout the electromagnetic radiation spectrum (e.g., UV, ionizing (x-rays and gamma rays), cosmic). For example, metal-ion infused fabrics could be sewn into wearable garments or covers utilized by health care professionals, patients, military personnel, aviation professionals, shipbuilders, outdoorsmen, and others. The garments or covers may be used by themselves or in conjunction with other radiation shielding devices and garments and/or may be a part of a system that incorporates ALARA (“as low as reasonably achievable”) principles of time, distance and shielding. Due to the controlled and in some examples high amounts of infused metal ions, the fabrics and textiles may resist degradation even with repeated wear, laundering and/or exposure to radiation and outdoor elements. Additional, metal-ion infused fabrics and textiles may be useful for absorbing, wicking, emitting or otherwise displacing heat and/or moisture due to the tailorable conductivity and hydrophilicity, and thus they may have applications in clothing, furniture, and other fabric-based products. By incorporating electrically conductive metal ions (e.g., Cu) into polymers as described in this disclosure, it is possible to produce electrically conductive fibers, fabrics, clothing, and other polymer-based products.

### EXAMPLES

### Fabrication of Metal Ion-Infused Polymers

Metal ion-infused polymers were created by dissolving metals into 1N HNO₃ or aqua regia (a mixture of 1N HNO₃ and 0.1N HCl) for 1 hour and at concentrations indicated below and adding the dissolved metal solutions into respective polymers dissolved into solvents (specifically chloroform) to achieve stated concentrations. Then, after mixing, the the metal ion-polymer mixtures were added in liquid form to a commercially available supercritical CO₂ device (SFE Lab 100 ml) for 24 hours to remove the solvent and HNO₃. Several precursor materials have been used, including Zn, Se, TiO₂, CuO, and WC. Several polymers have also been used, including polypropylene (PP, Sigma, cat no. 428175 (amorphous), 428116 (MW=12,000), 427888 (MW=250,000), and 427861 (MW=340,000)), PET, PU, and polyesters. After being subjected to the supercritical CO₂ device to remove the unreacted HNO₃ and solvent, the liquid metal ion-infused polymer mixtures were placed into a vacuum oven for 24 hrs to allow the polymer to cure while continuing to remove the HNO₃ and solvent for up to 48 hrs. After solidification, the resulting metal ion-infused polymer was added to a commercially available pelletizer (Extrud-O-Mix by Bepex) to break the solid polymer into polymer pellets, which were further processed for material characterization and mechanical and cytocompatibility property testing, as described below.

TABLE 1
Examples of Metal-ion Infused Polymers Created

| | Precursor | | |
|---|---|---|---|
| Precursor | Material | | Polymer Melt or |
| Material | Wt. % | Polymer Composition | Solution |
| WC | 55 | Polypropylene (PP) | Polymer solution |
| | | (amorphous to 34,000 MW) | |
| WC and Se | 65 | Polypropylene (PP) | Polymer solution |
| TiO₂ | 20 | Polyurethane | Polymer melt |
| TiO₂ | 41 | Polyethylene terapthalate | Polymer solution |
| WC, WC | 41 | Polypropylene (PP) | Polymer solution |
| and Se | | (amorphous to 34,000 MW) | |
| WC | 41 | Polyester | Polymer solution |

### Characterization

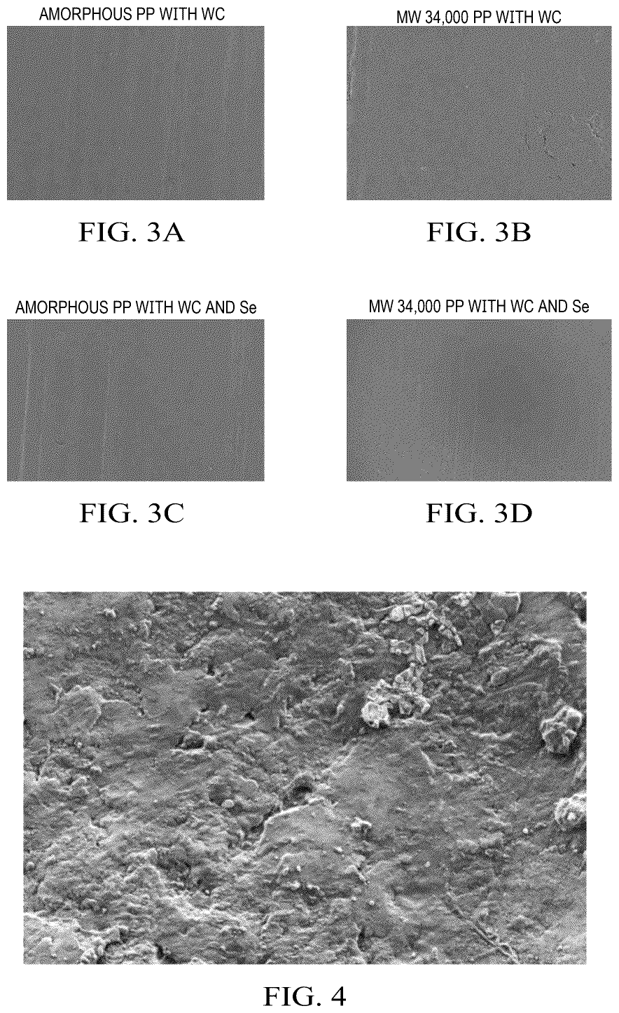

To determine the presence of metal ions or particles in the polymer samples, the above-mentioned pellets were heat dissolved at 120° C. for 2 hrs, and once liquified, placed into a mold of 1 by 1 cm³ for assessment using scanning electron microscopy (SEM). As can be seen in the SEM images of FIGS. 3A-3D, when adding the WC (and Se) to PP at 55 wt. %, no nano- or microscale particles were observed using scanning electron microscopy (SEM), thus confirming the formation of a metal ion-infused polymer. It is found that, above metal concentrations of 55 wt. %, nanoparticles of WC (and Se) begin to appear, as shown in the SEM image of FIG. 4 for a polypropylene sample with WC and Se incorporated at a concentration of 65 wt. %.

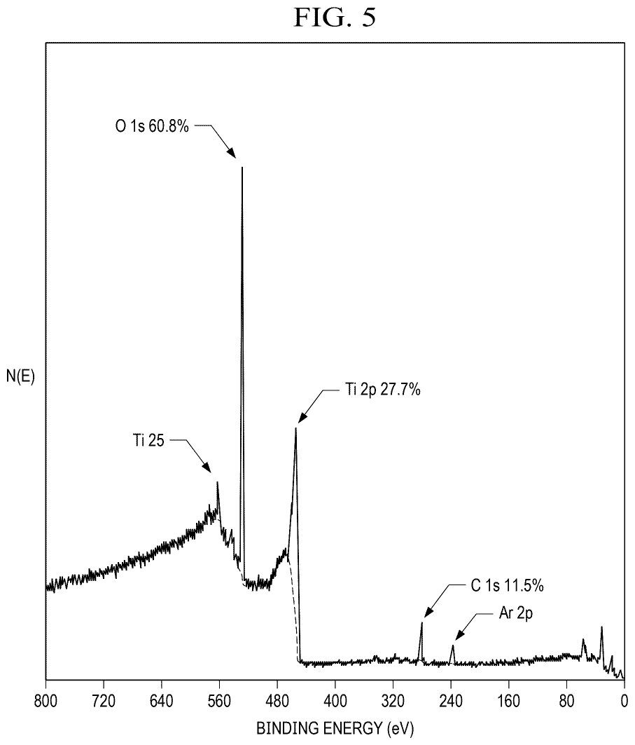

X-ray photoelectron spectroscopy (XPS) further confirmed the presence of the metals in the polymer composites. FIG. 5 shows energy dispersive x-ray spectroscopy (EDS) of a Ti ion-infused PU sample revealed the presence of titanium with no nitrogen from the acid (HNO₃) remaining.

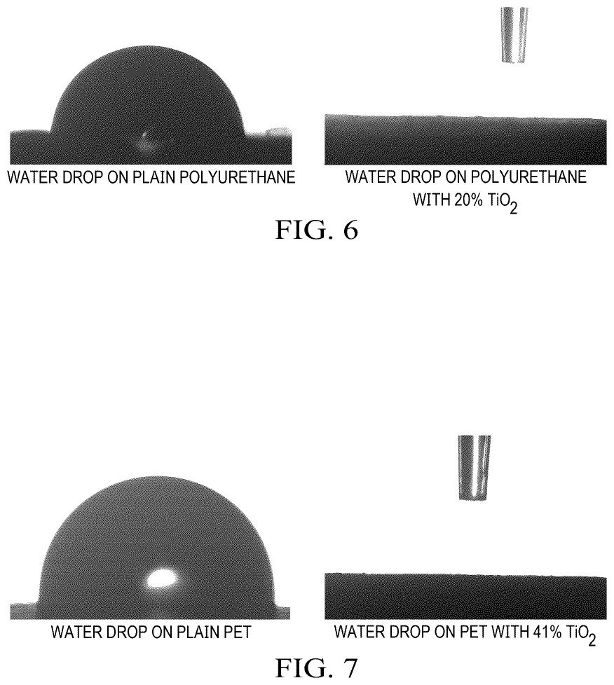

Surface energy was also determined by placing water droplets on the surfaces of the metal ion-infused polymers, in particular, Ti ion-infused PU and Ti ion-infused PET, as shown in FIGS. 6 and 7, respectively. The results are summarized in Tables 2 and 3. Differences in water contact angles further demonstrated the incorporation of metal ions into the polymers, since the metal ions are more hydrophilic than the unmodified polymers.

TABLE 2
Water contact angle and surface energy comparison for unmodified
polyurethane and Ti ion-infused polyurethane.

| | Water Contact Angle | Surface Energy |
|---|---|---|
| Sample | (degrees) | (mJ/m²) |
| Plain polyurethane | 88 | 44 |
| Polyurethane with 10% TiO₂ | 10 | 75 |
| Polyurethane with 20% TiO₂ | 0 | >125 |

TABLE 3
Water contact angle and surface energy comparisons
for unmodified PET and Ti ion-infused PET.

| | Water Contact Angle | Surface Energy |
|---|---|---|
| Sample | (degrees) | (mJ/m²) |
| Plain PET | 87 | 40 |
| PET with 25% TiO₂ | 42 | 63 |
| PET with 41% TiO₂ | 0 | >125 |

### Mechanical Properties

Mechanical properties of the metal ion-infused polymers were determined by taking the above-mentioned pellets, heat dissolving them at 120° C. for 2 hours and, once liquified, placing them into appropriate molds for MTS testing. Specifically, standard dog bone tensile specimens were made for tensile testing while standard disk shapes were made for compression tests. ASTM standards (ASTM Compression C237 and ASTM Tensile D638) were followed and experiments were completed in triplicate for a minimum of three times. Mechanical tests confirmed the introduction of metal ions into the polymers as demonstrated by the significantly greater tensile strength at yield, ultimate tensile strength, flexural yield strength, elongation at break, and compressive yield strength for PET incorporated with 41 wt % WC compared to pure PET. See Table 4.

TABLE 4
Mechanical properties comparisons for
unmodified PET and W ion-infused PET.

| | Tensile | Ultimate | Flexural | | Compressive |
|---|---|---|---|---|---|
| | Strength | Tensile | Yield | Elongation | Yield |
| | at Yield | Strength | Strength | at Break | Strength |
| Sample | (MPa) | (MPa) | (MPa) | (%) | (MPa) |
| Plain PET | 62 | 230 | 119 | 175 | 82 |
| PET with | 190 | 675 | 145 | 327 | 216 |
| 41% WC | | | | | |

### In Vitro Biological Testing

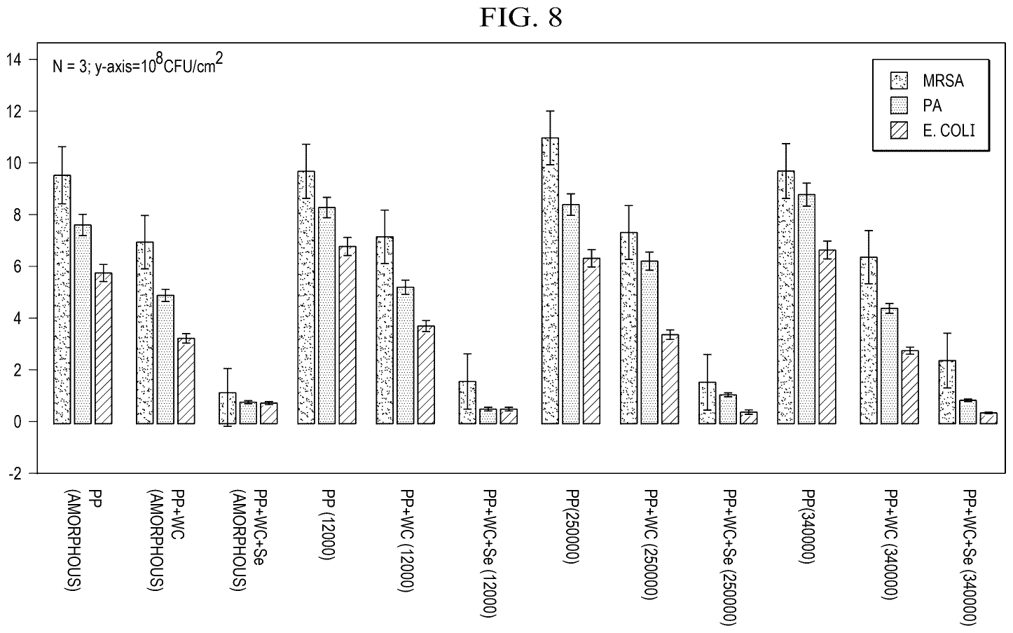

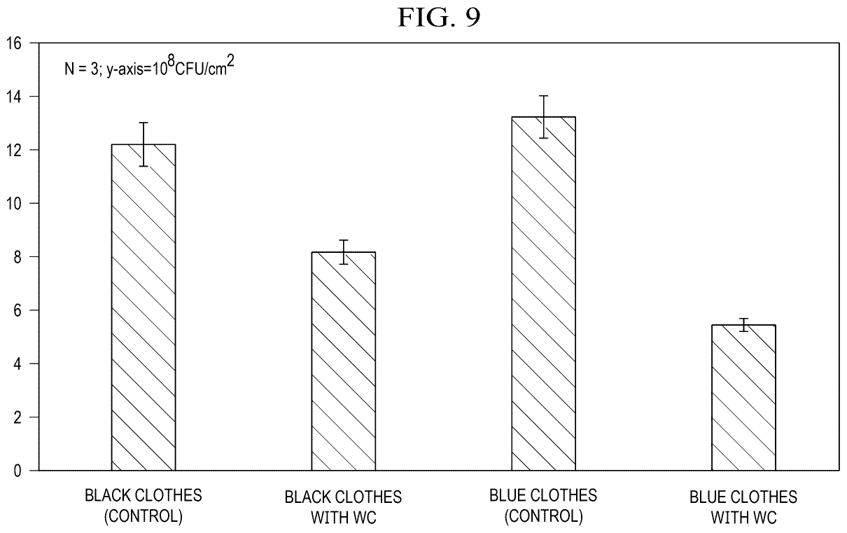

To determine the anti-bacterial and cytocompatibility properties of the metal ion diffused polymers, the above-mentioned pellets were heat dissolved at 120° C. for 2 hrs and, once liquified, placed into a mold 1 by 1 cm³ for assessment. Standard microbiology assays were performed in which respective bacteria (purchased from ATCC) were seeded on substrates at 10⁸ CFU/cm² and allowed to grow for 24 hrs. At that time, bacteria were removed using trypsin and counted in a Coulter cell counter. Results showed significantly less bacteria when WC and Se were added to PP (FIG. 8) or WC was added to polyester clothes (FIG. 9). Experiments were repeated in triplicate and repeated at three separate times.

### Electrical Conductivity Testing

10 mg of CuO nanoparticles (Nanophase Technologies) were added to 10 ml of 0.1 M HNO₃ for 1 hour until completely dissolved. The dissolved CuO was then added to appropriately weighed PLGA (30% PLA/70% PGA wt.; Polysciences) pellets previously dissolved in chloroform to create 10, 15, and 20 wt. % CuO:PLGA samples. The combined CuO:PLGA solution was then added to a supercritical CO₂ system to remove the solvents, poured into petri dishes, and cut into 1 cm². Samples were then tested for conductivity using a voltmeter (Fisher Scientific). Experiments were repeated in triplicate.

Results showed the ability to transform a non-conductive PLGA into a conductive polymer through the addition of CuO (Table 5). Moreover, conductivity increased with increasing concentrations of CuO in PLGA. These results further support that CuO was added to PLGA during the synthesis process.

TABLE 5
Electrical Conductivity Test Results

| Samples | Conductivity (S/m)* |
|---|---|
| PLGA | 0 |
| PLGA:CuO 10 wt % | 1.01 × 10⁶ |
| PLGA:CuO 15 wt % | 1.45 × 10⁶ |
| PLGA:CuO 20 wt % | 2.1 × 10⁶ |

*Pure CuO has a conductivity of 5.96 × 10⁷ S/m

This disclosure includes the following aspects:

A first aspect relates to a method of making a metal ion-infused polymer, the method comprising: dissolving a precursor material comprising a metal in an acid solution, thereby forming a metal ion solution; mixing the metal ion solution with a solution or melt comprising a polymer, thereby forming a metal ion-polymer mixture; exposing the metal ion-polymer mixture to a supercritical fluid, whereby acid(s) and/or solvent(s) are removed from the metal-ion polymer mixture; and after exposure to the supercritical fluid, drying the metal-ion polymer mixture to form a metal ion-infused polymer.

A second aspect relates to the method of the first aspect, wherein an amount of the precursor material dissolved in the acid solution and an amount of the polymer in the solution or melt are selected such that a weight percentage of the precursor material is in a range from 0.0001 wt. % to less than 65 wt. %.

A third aspect relates to the method of any preceding aspect, wherein an amount of the precursor material dissolved in the acid solution is selected to provide a weight percentage of metal ions in the metal ion-infused polymer in a range from 0.0001 wt. % to less than 65 wt. %.

A fourth aspect relates to the method of any preceding aspect, wherein an amount of the precursor material dissolved in the acid solution is selected to provide a weight percentage of metal ions and additional element(s) in the metal ion-infused polymer in a range from 0.0001 wt. % to less than 65 wt. %.

A fifth aspect relates to the method of any preceding aspect, wherein the weight percentage is at least 15 wt. %, at least 25 wt. %, at least 35 wt. %, or at least 45 wt. %, and/or up to 55 wt. %, or up to 60 wt. %.

A sixth aspect relates to the method of any preceding aspect, wherein the metal is selected from the group consisting of: Ag, Au, Cu, Mg, Se, Sn, W, Zn, Ti, Ta, Ba, and Al.

A seventh aspect relates to the method of any preceding aspect, wherein the precursor material comprises a pure metal, a metal oxide, or a metal carbide.

An eighth aspect relates to the method of the preceding aspect, wherein the metal oxide is selected from the group consisting of: titanium dioxide, silver oxide, gold oxide, copper oxide, magnesium oxide, selenium oxide, tin oxide, tungsten oxide, zinc oxide, titanium oxide, tantalum oxide, barium oxide, and/or aluminum oxide, and/or wherein the metal carbide is selected from the group consisting of: tungsten carbide, titanium carbide, magnesium carbide, tantalum carbide and aluminum carbide.

A ninth aspect relates to the method of any preceding aspect, wherein the precursor material includes at least two different metals.

A tenth aspect relates to the method of the preceding aspect, wherein the at least two different metals include W and Se, Ti and Se, W and Ti, Ti and Ag, Ti and Zn and/or Ti and Cu.

An eleventh aspect relates to the method of any preceding aspect, wherein the polymer comprises a thermoplastic polymer.

A twelfth aspect relates to the method of any preceding aspect, wherein the polymer comprises a natural polymer.

A thirteenth aspect relates to the method of any preceding aspect, wherein the polymer comprises a biocompatible polymer.

A fourteenth aspect relates to the method of any preceding aspect, wherein the polymer is selected from the group consisting of: poly(methyl methacrylate) (PMMA), polyetheretherketone (PEEK), polyetherketoneketone (PEKK), polypropylene (PP), polyester, polyurethane (PU), polyethylene terephthalate (PET), poly(lactic-co-glycolic) acid (PLGA), poly(vinyl chloride) (PVC), poly(vinylidene difluoride) (PVDF), collagen, alginate, chitosan, silk, cellulose, and decellularized tissue.

A fifteenth aspect relates to the method of any preceding aspect, wherein the solution comprising the polymer further comprises a solvent selected from the group consisting of: butylated hydroxytoluene (BHT), chloroform, dichloroacetic acid, dichloromethane (DCM), dimethyl sulfoxide (DMSO), tetrahydrofuran (THF), 1,2,4-trichlorobenzene (TCB), water, and aqueous solution.

A sixteenth aspect relates to the method of any preceding aspect, wherein the acid solution includes one or more acids selected from the group consisting of: nitric acid, hydrochloric acid, and sulfuric acid.

A seventeenth aspect relates to the method of the preceding aspect, wherein the acid solution comprises an aqua regia solution.

An eighteenth aspect relates to the method of the sixteenth or seventeenth aspects, wherein the one or more acids are selected based on their compatibility with the polymer.

A nineteenth aspect relates to the method of any preceding aspect, wherein the mixing is carried out using sonication.

A twentieth aspect relates to the method of any preceding aspect, wherein the supercritical fluid is supercritical CO₂.

A twenty-first aspect relates to the method of any preceding aspect, wherein the exposure of the metal ion-polymer mixture to the supercritical fluid takes place for a time duration from 2 minutes to 48 hours.

A twenty-second aspect relates to the method of any preceding aspect, wherein the drying comprises curing or solidifying the polymer; and/or removing any remaining acid(s) and/or solvent(s).

A twenty-third aspect relates to the method of any preceding aspect, wherein the drying is carried out under vacuum conditions for 12 hours to 48 hours.

A twenty-fourth aspect relates to the method of any preceding aspect, wherein, upon exposure to a water droplet, the metal ion-infused polymer exhibits a water contact angle of less than 50 degrees, less than 40 degrees, or less than 20 degrees, and/or as low as 10 degrees, or as low as 0 degrees.

A twenty-fifth aspect relates to the method of any preceding aspect, wherein the metal ion-infused polymer has a surface energy of at least 60 mJ/m², at least 75 mJ/m², at least 100 mJ/m², at least 125 mJ/m², and/or as high as 130 mJ/m².

A twenty-sixth aspect relates to the method of any preceding aspect, wherein the metal ion-infused polymer exhibits a tensile strength 1.1 to 3 times higher than that of the same polymer prior to infusion with metal ions.

A twenty-seventh aspect relates to the method of any preceding aspect, wherein the metal ion-infused polymer exhibits a compressive strength 1.1 to 3 times higher than that of the same polymer prior to infusion with metal ions.

A twenty-eighth aspect relates to the method of any preceding aspect, wherein, upon exposure to bacteria, the metal ion-infused polymer exhibits a bacterial colonization reduced by at least 20% or by at least 50% compared to the same polymer prior to infusion with metal ions.

A twenty-ninth aspect relates to the method of any preceding aspect, further comprising exposing the metal ion-infused polymer to ultraviolet light.

A thirtieth aspect relates to the method of any preceding aspect, wherein the metal ion-infused polymer includes a polymer backbone with metal ions incorporated therein.

A thirty-first aspect relates to the method of any preceding aspect, wherein the metal ion-infused polymer includes a polymer backbone with metal ions bound thereto.

A thirty-second aspect relates to the method of any preceding aspect, wherein the metal ion-infused polymer is devoid of nano- or microparticles comprising the metal.

A thirty-third aspect relates to the method of any preceding aspect, further comprising granulating the metal ion-infused polymer.

A thirty-fourth aspect relates to the method of any preceding aspect, further comprising extruding, melt spinning, electrospinning, molding, 3D printing, twisting, weaving, and/or knitting to form a metal ion-infused product comprising the metal ion-infused polymer.

A thirty-fifth aspect relates to the method of any preceding aspect, wherein the metal ion-infused product has a form of a fiber, yarn, suture, surgical thread, fabric, textile, film, coating, and/or shaped body.

A thirty-sixth aspect relates to a metal-ion infused polymer made by the method of any preceding aspect.

A thirty-seventh aspect relates to a metal ion-infused polymer comprising: a polymer backbone; and metal ions bound to or incorporated into the polymer backbone, wherein the metal ions are present at a concentration in a range from 0.0001 wt. % to less than 65 wt. %.

A thirty-eighth aspect relates to the metal ion-infused polymer of the preceding aspect, further comprising one or more additional elements introduced during fabrication from a precursor material.

A thirty-ninth aspect relates to the metal ion-infused polymer of any preceding aspect, wherein the precursor material comprises a metal carbide or a metal oxide.

A fortieth aspect relates to the metal ion-infused polymer of any preceding aspect, wherein the concentration includes the metal ions and some amount, or all, of the one or more additional elements introduced during fabrication.

A forty-first aspect relates to the metal ion-infused polymer of any preceding aspect, wherein the concentration is at least 35 wt. %, or at least 45 wt. %, and/or up to 55 wt. %, or up to 60 wt. %.

A forty-second aspect relates to the metal ion-infused polymer of any preceding aspect, wherein the polymer backbone comprises a thermoplastic polymer.

A forty-third aspect relates to the metal ion-infused polymer of any preceding aspect, wherein the polymer backbone comprises a natural polymer.

A forty-fourth aspect relates to the metal ion-infused polymer of any preceding aspect, wherein the polymer backbone comprises a biocompatible polymer.

A forty-fifth aspect relates to the metal ion-infused polymer of any preceding aspect, wherein the polymer backbone comprises a polymer selected from the group consisting of: poly(methyl methacrylate) (PMMA), polyetheretherketone (PEEK), polyetherketoneketone (PEKK), polypropylene (PP), polyester, polyurethane (PU), polyethylene terephthalate (PET), poly(lactic-co-glycolic) acid (PLGA), poly(vinyl chloride) (PVC), poly(vinylidene difluoride) (PVDF), collagen, alginate, chitosan, silk, cellulose, and decellularized tissue.

A forty-sixth aspect relates to the metal ion-infused polymer of any preceding aspect, wherein the metal ions comprise Ag, Au, Cu, Mg, Se, Sn, W, Zn, Ti, Ta, Ba, and/or Al ions.

A forty-seventh aspect relates to the metal ion-infused polymer of any preceding aspect, further comprising, upon exposure to a water droplet, a water contact angle of less than 50 degrees, less than 40 degrees, or less than 20 degrees, and/or as low as 10 degrees, or as low as 0 degrees.

A forty-eighth aspect relates to the metal ion-infused polymer of any preceding aspect, further comprising a surface energy of at least 60 mJ/m², at least 75 mJ/m², at least 100 mJ/m², at least 125 mJ/m², and/or as high as 130 mJ/m².

A forty-ninth aspect relates to the metal ion-infused polymer of any preceding aspect, further comprising a tensile strength 1.1 to 3 times higher than that of the same polymer prior to infusion with metal ions.

A fiftieth aspect relates to the metal ion-infused polymer of any preceding aspect, further comprising a compressive strength 1.1 to 3 times higher than that of the same polymer prior to infusion with metal ions.

A fifty-first aspect relates to the metal ion-infused polymer of any preceding aspect, further comprising, upon exposure to bacteria, a bacterial colonization reduced by at least 20% or by at least 50% compared to the same polymer prior to infusion with metal ions.

A fifty-second aspect relates to the metal ion-infused polymer of any preceding aspect being devoid of metal-containing nano- or microparticles.

A fifty-third aspect relates to the metal ion-infused polymer of any preceding aspect, wherein the metal ions are homogeneously distributed therein.

A fifty-fourth aspect relates to a metal ion-infused product comprising: a fiber, yarn, suture, surgical thread, fabric, textile, film, coating and/or shaped body including a metal ion-infused polymer comprising: a polymer backbone; and metal ions bound to or incorporated into the polymer backbone, wherein the metal ions are present at a concentration in a range from 0.0001 wt. % to less than 65 wt. %.

A fifty-fifth aspect relates to the metal ion-infused product of the preceding aspect, wherein the metal ion-infused polymer further comprises one or more additional elements introduced during fabrication from a precursor material.

A fifty-sixth aspect relates to the metal ion-infused product of any preceding aspect, wherein the precursor material comprises a metal carbide or a metal oxide.

A fifty-seventh aspect relates to the metal ion-infused product of the preceding aspect, wherein the concentration includes the metal ions and some amount, or all, of the one or more additional elements introduced during fabrication.

A fifty-eighth aspect relates to a medical device comprising the metal ion-infused product of any preceding aspect.

A fifty-ninth aspect relates to the medical device of the preceding aspect comprising a catheter, suture, hernia mesh, spinal interbody, hip, shoulder, and/or other joint component, suture anchor, and/or other implant or implant composition.

A sixtieth aspect relates to a radiation shielding device comprising the metal ion-infused product of any preceding aspect.

A sixty-first aspect relates to a garment or cover comprising the metal ion-infused product of any preceding aspect.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

What is claimed is:

1. A method of making a metal ion-infused polymer, the method comprising:
dissolving a precursor material comprising a metal in an acid solution, thereby forming a metal ion solution;
mixing the metal ion solution with a solution or melt comprising a polymer, thereby forming a metal ion-polymer mixture;
exposing the metal ion-polymer mixture to a supercritical fluid, whereby acid(s) and/or solvent(s) are removed from the metal-ion polymer mixture; and
after exposure to the supercritical fluid, drying the metal-ion polymer mixture to form a metal ion-infused polymer.

2. The method of claim 1, wherein the metal is selected from the group consisting of: Ag, Au, Cu, Mg, Se, Sn, W, Zn, Ti, Ta, Ba, and Al.

3. The method of claim 1, wherein the precursor material comprises a pure metal, a metal oxide, or a metal carbide.

4. The method of claim 1, wherein the precursor material includes at least two different metals.

5. The method of claim 4, wherein the at least two different metals include W and Se, Ti and Se, W and Ti, Ti and Ag, Ti and Zn, and/or Ti and Cu.

6. The method of claim 1, wherein the polymer is selected from the group consisting of: poly(methyl methacrylate) (PMMA), polyetheretherketone (PEEK), polyetherketoneketone (PEKK), polypropylene (PP), polyester, polyurethane (PU), polyethylene terephthalate (PET), poly(lactic-co-glycolic) acid (PLGA), poly(vinyl chloride) (PVC), poly(vinylidene difluoride) (PVDF), collagen, alginate, chitosan, silk, cellulose, and decellularized tissue.

7. The method of claim 1, wherein the drying comprises curing or solidifying the polymer; and/or
removing any remaining acid(s) and/or solvent(s).

8. The method of claim 1, further comprising exposing the metal ion-infused polymer to ultraviolet light.

9. The method of claim 1, further comprising granulating the metal ion-infused polymer.

10. The method of claim 1, further comprising extruding, melt spinning, electrospinning, molding, 3D printing, twisting, weaving, and/or knitting to form a metal ion-infused product comprising the metal ion-infused polymer.

11. A metal ion-infused polymer comprising:
a polymer backbone; and
metal ions bound to or incorporated into the polymer backbone,
wherein the metal ions are present at a concentration in a range from 0.0001 wt. % to less than 65 wt. %.

12. The metal ion-infused polymer of claim 11, wherein the concentration is in a range from 35 wt. % to 60 wt. %.

13. The metal ion-infused polymer of claim 11, wherein the metal ions comprise Ag, Au, Cu, Mg, Se, Sn, W, Zn, Ti, Ta, Ba, and/or Al ions.

14. The metal ion-infused polymer of claim 11 comprising, upon exposure to a water droplet, a water contact angle of less than 50 degrees.

15. The metal ion-infused polymer of claim 11 comprising a surface energy in a range from 60 mJ/m² to 130 mJ/m².

16. The metal ion-infused polymer of claim 11 comprising, upon exposure to bacteria, a bacterial colonization reduced by at least 20% compared to the polymer prior to infusion with metal ions.

17. The metal ion-infused polymer of claim 11 being devoid of metal-containing nano- or microparticles.

18. A metal ion-infused product comprising:
a fiber, yarn, suture, surgical thread, fabric, textile, film, coating and/or shaped body including a metal ion-infused polymer comprising:
a polymer backbone; and
metal ions bound to or incorporated into the polymer backbone,
wherein the metal ions are present at a concentration in a range from 0.0001 wt. % to less than 65 wt. %.

19. The metal ion-infused product of claim 18 being part or all of a medical device, a radiation shielding device, a garment and/or a cover.

20. The metal ion-infused product of claim 19, wherein the medical device comprises a catheter, suture, hernia mesh, spinal interbody, hip, shoulder, and/or other joint component, suture anchor, and/or other implant or implant composition.
